(19) United States
(12) Patent Application Publication
(10) Pub. No.: US 2017/0372851 A1
(43) Pub. Date: Dec. 28, 2017

(54) SWITCH

(71) Applicant: OMRON Corporation, Kyoto-shi, KYOTO (JP)

(72) Inventor: Yohei TSUKANAKA, Konan-shi (JP)

(73) Assignee: OMRON Corporation, Kyoto-shi, KYOTO (JP)

(21) Appl. No.: 15/544,558

(22) PCT Filed: Aug. 13, 2015
(86) PCT No.: PCT/JP2015/072906

§ 371 Date: Jul. 19, 2017

(30) Foreign Application Priority Data
Feb. 23, 2015 (JP) 2015-033327

(51) Int. Cl. H01H 1/36; H01H 21/24; H01H 21/22; H01H 21/42; H01H 21/04

(52) U.S. Cl. CPC H01H 1/36; H01H 21/42; H01H 21/04; H01H 21/22; H01H 21/24

(57) ABSTRACT

A switch includes a base; switch parts having a common fixed contact and a first and a second fixed contacts; a slide body having a second movable contact configured to be in contact with the common fixed contact and a first movable contact electrically connected to the common movable contact and configured to be in contact with the first and the second fixed contacts, the slide body rotatably supported by the base; a cover mounted to the base; an operation lever supported by the cover to rotate the slide body; and a reverse spring which biases the slide body and the operation lever to be close to each other. The first movable contact slides to be in contact with or separate from the first and the second fixed contacts, and the second movable contact slides while in contact with the common fixed contact, by rotation of the slide body.

### TECHNICAL FIELD

The present invention relates to a switch.

### BACKGROUND ART

Conventionally, for example, a switch disclosed in Patent Document 1 is known. This switch is provided with an operation member; a fixed contact provided with a common contact, a first switching contact and a second switching contact; a movable contact to be in contact with the common contact and provided with a contact part to be in contact with either the first switching contact or the second switching contact; and a snap action mechanism for moving the movable contact to be in contact with the first switching contact or the second switching contact by means of pressing operation of the operation member.

### PRIOR ART DOCUMENT

### Patent Document

Patent Document 1: Japanese Unexamined Patent Publication No. 2010-73662

### SUMMARY OF THE INVENTION

### Problem to be Solved by the Invention

In the conventional switch described above, the movable contact is configured to slide and make contact with the switching contact, and thereby a switch having high contact reliability is provided. The present inventors found that a switch having higher contact reliability compared to the conventional switch described above can be obtained.

Accordingly, an object of the present invention is to provide a switch having high contact reliability.

### Means for Solving the Problem

A switch according to the present invention is derived to solve the problem described above and is provided with a base, at least one switch part arranged on the base and having a common fixed contact and at least one open and close fixed contact arranged with a predetermined interval between the common fixed contact and the at least one open and close fixed contact, a slide body having a common movable contact configured to be in slidably contact with the common fixed contact and an open and close movable contact electrically connected to the common movable contact and configured to be in slidably contact with or separate from the open and close fixed contact, the slide body being rotatably supported by the base, a cover mounted to the base to cover the switch part and the slide body, an operation body movably supported by the base or the cover, and an elastic body configured to bias the slide body and the operation body to be close to each other. The slide body is supported to rotate by a snap action due to elastic force of the elastic body when the operation body is moved to a predetermined position. The open and close movable contact slides in association with rotation of the slide body so as to be in contact with or separate from the open and close fixed contact. The common movable contact slides in association with the rotation of the slide body while in contact with the common fixed contact.

### Effects of the Invention

According to the switch of the present invention, the slide body rotates by the snap action due to the elastic force of the elastic body when the operation body is moved to the predetermined position, and the open and close movable contact slides in association with the rotation of the slide body such that the open and close movable contact and the open and close fixed contact are in contact with each other or separate from each other, and the common movable contact slides in association with the rotation of the slide body while in contact with the common fixed contact. Thus, a foreign substance or the like formed on each surface of the first movable contact, the second movable contact and the fixed contacts is wiped, and therefore a wiping effect can be obtained. As a result, contact reliability can be improved.

Further, the second movable contact slides while in contact with the common fixed contact by the rotation of the slide body. Thus, all switch parts can be switched at substantially the same time in a case in which a plurality of the switch parts is arranged.

As one embodiment of the present invention, the operation body may be provided with a rotation part rotatably supported by the base or the cover and an operation part joined to the rotation part, and the slide body and the rotation part may be arranged to have different pivots, respectively.

According to this embodiment, the slide body and the rotation part have the different pivots respectively, and thereby pressing force to the operation body necessary to rotate the slide body can be reduced compared to a switch in which the slide body and the rotation part have the same pivot. That is, large driving force to the slide body can be obtained by small pressing force to the operation body. As a result, the switch part can be switched easily.

As one embodiment of the present invention, the slide body may be provided with a movable touch piece on which a pair of the open and close movable contacts and a pair of the common contacts are arranged, and each of the pair of the open and close movable contacts and the pair of the common movable contacts is mounted in a rotation axis direction of the slide body and mounted in a movable manner such that the pair of the open and close movable contacts and the pair of the common movable contacts elastically clamp the open and close fixed contact and the common fixed contact respectively.

According to this embodiment, even if an error is generated between a position in which the switch part is arranged and a position in which the switch part is designed, the movable touch piece is moved in accordance with the position of the switch part when the slide body is mounted to the base, and thereby a position of the movable touch piece is automatically adjusted. Thus, since it is not necessary to control positional accuracy of the switch part severely, a manufacturing cost can be reduced.

### BRIEF DESCRIPTION OF THE DRAWINGS

FIG. 1 is a perspective view illustrating one embodiment of a switch according to the present invention.

FIG. 2 is a perspective view illustrating a state in which a cover of the switch shown in FIG. 1 is removed.

FIG. 3 is an exploded perspective view of the switch shown in FIG. 1.

FIG. 4 is an exploded perspective view of the switch shown in FIG. 1 seen from a different direction against FIG. 3.

FIG. 5 is a view for describing an assembling method of the switch shown in FIG. 1.

FIG. 6 is a view for describing the assembling method of the switch shown in FIG. 1 following FIG. 5.

FIG. 7 is a view for describing the assembling method of the switch shown in FIG. 1 following FIG. 6.

FIG. 8 is a view for describing the assembling method of the switch shown in FIG. 1 following FIG. 7.

FIG. 9 is a view for describing operation of the switch shown in FIG. 1.

FIG. 10 is a view for describing the operation of the switch shown in FIG. 1 following FIG. 9.

FIG. 11 is a view for describing the operation of the switch shown in FIG. 1 following FIG. 10.

FIG. 12 is a view for describing the operation of the switch shown in FIG. 1 following FIG. 11.

FIG. 13 is a view for describing the operation of the switch shown in FIG. 1 following FIG. 12.

FIG. 14 is a view for describing the operation of the switch shown in FIG. 1 following FIG. 13.

FIG. 15 is a view for describing another embodiment of the switch shown in FIG. 1.

FIG. 16 is another view for describing another embodiment of the switch shown in FIG. 1.

FIG. 17 is another view for describing another embodiment of the switch shown in FIG. 1.

### MODE FOR CARRYING OUT THE INVENTION

Hereinafter, embodiments of a switch according to the present invention is described with reference to attached drawings. Here, in the description below, terminologies which indicate directions such as “up”, “down”, “left”, “right” and other terminologies including thereof are used for describing a configuration illustrated in the drawings. These terminologies are used for facilitating understanding of the embodiments through the drawings. Accordingly, these terminologies are not always matched with directions when each embodiment of the present invention is actually used, and the scope of the invention described in Claims should not be limited by these terminologies.

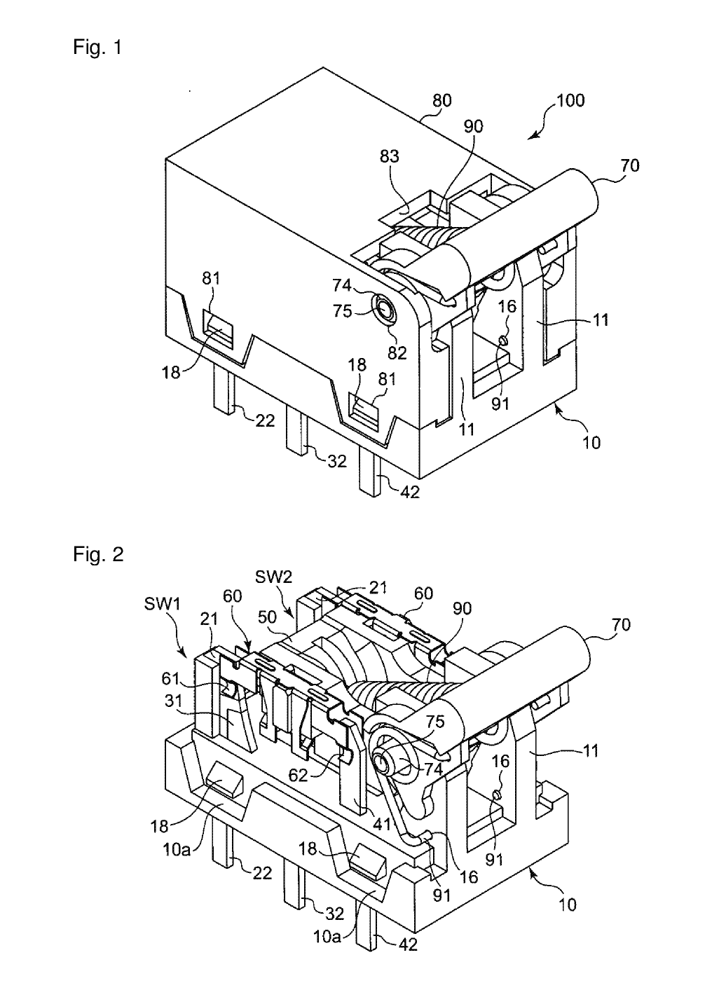

As shown in FIG. 1 and FIG. 2, a switch 100 according to one embodiment of the present invention is provided with a base 10, a slide body 50 and an operation lever 70 as one example of an operation body arranged on the base 10, and a cover 80 arranged on the base 10 to cover the slide body 50.

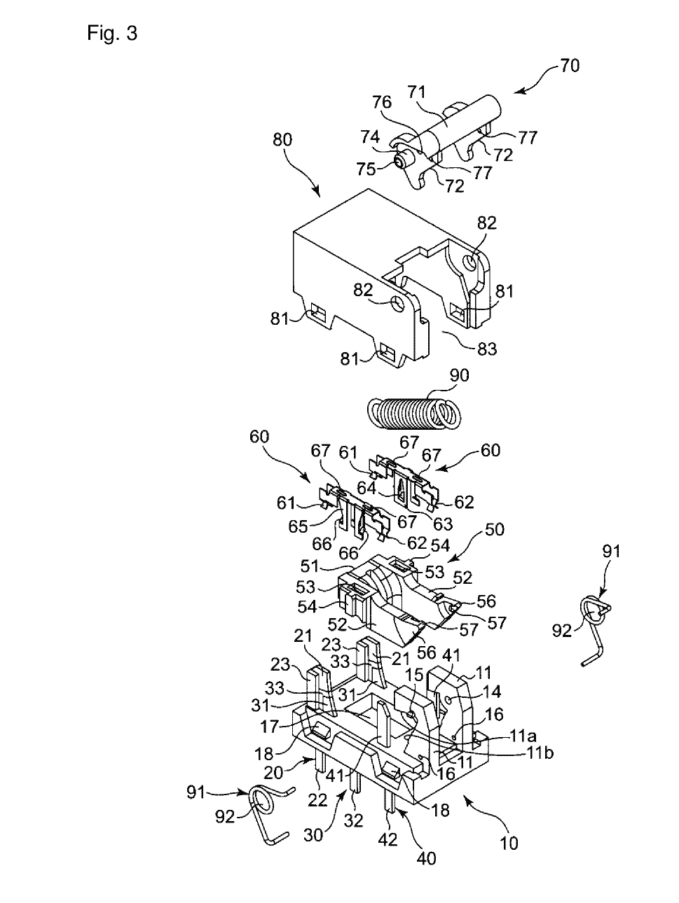

As shown in FIG. 3, two sets of a first fixed contact terminal 20, a second fixed contact terminal 30 and a common fixed contact terminal 40 are arranged on the base 10. Two movable touch pieces 60 are mounted to the slide body 50. Further, a reverse spring 90 as one example of an elastic body joined to the slide body 50 and the operation lever 70, and two return springs 91 joined to the base 10 and the operation lever 70 are further arranged on the switch 100.

As shown in FIG. 3 to FIG. 5, the base 10 is formed in a rectangular shape, which is defined by a pair of long sides and a pair of short sides, seen from an upper side. A pair of support parts 11 for supporting the slide body 50 and the operation lever 70 is arranged on the base 10.

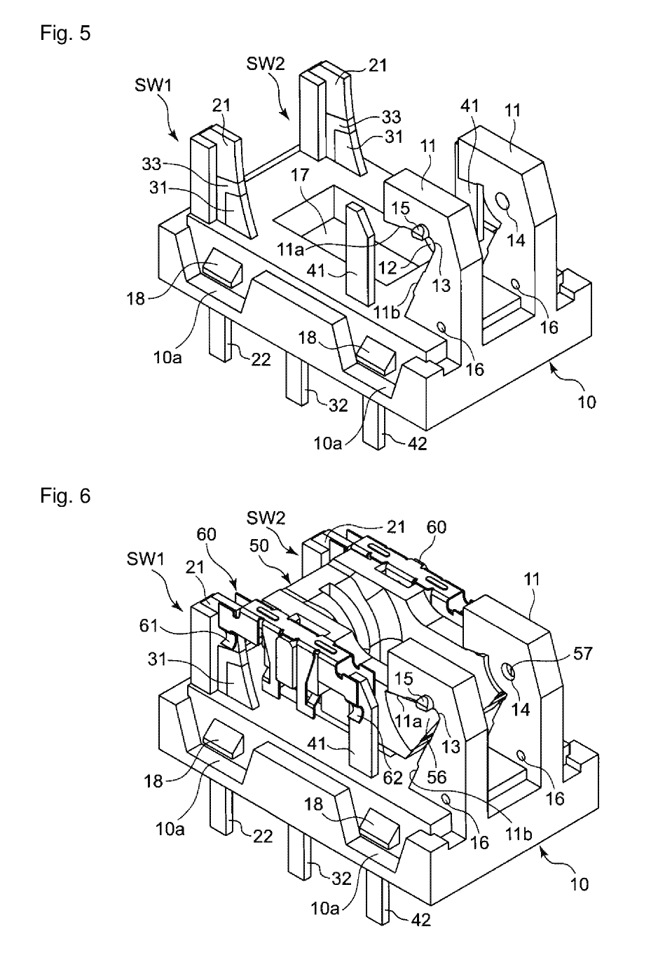

As shown in FIG. 3 and FIG. 5, the pair of the support parts 11 is arranged at an edge part of one short side of an upper surface of the base 10 so as to be projected from the upper surface of the base 10. The support parts 11 are arranged along the short side of the base 10 so as to face each other.

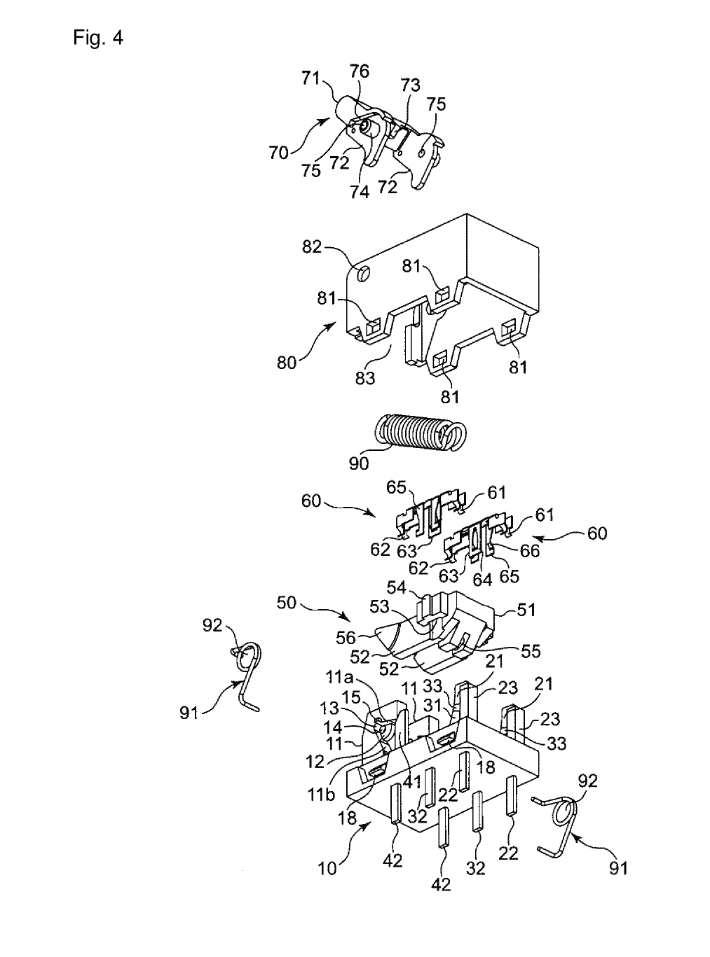

The support part 11 is provided with a vertical part extended upwardly from the upper surface of the base 10, and a horizontal part extended in a longitudinal direction of the base 10 from an upper end of the vertical part along the upper surface of the base 10. As shown in FIG. 4, a notch 12 is arranged at a joining part between a lower surface 11a of the horizontal part and a side surface 11b of the vertical part continued to the lower surface 11a. The notch 12 is arranged on an outward surface which does not face another support part 11. The notch 12 is provided with a rotation receiving part 13 which rotatably supports the slide body 50, and a slide body mount hole 14 for mounting the slide body 50. The lower surface 11a of the horizontal part of the support part 11 and the side surface 11b of the vertical part continued to the lower surface 11a are inclined and formed to define a rotation range of the slide body 50.

Further, a base projection 15 projected from the outward surface of the support part 11 is arranged at an upper side of the notch 12 of the support part 11. A spring mount hole 16 for mounting one end of the return spring 91 is arranged at a base part (lower end) of the vertical part.

A recess 10a corresponding to a shape of the cover 80 is arranged at an outer peripheral part of the upper surface of the base 10. A recess 17 formed in a rectangular shape seen from an upper side is arranged at a center potion of the upper surface of the base 10. Further, two mount projections 18 for mounting the cover 80 are arranged with a predetermined interval on each side surface of the base 10 parallel to the longitudinal direction of the base 10.

As shown in FIG. 3 to FIG. 5, the first fixed contact terminal 20, the second fixed contact terminal 30 and the common fixed contact terminal 40 are formed as a plate body formed by pressing one conductive plate and arranged on an edge part of the long side of the base 10 by means of insert molding. The first fixed contact terminal 20, the second fixed contact terminal 30 and the common fixed contact terminal 40 are arranged on one line, with the second fixed contact terminal 30 located between the first fixed contact terminal 20 and the common fixed contact terminal 40, so as to be apart from each other. Further, the first fixed contact terminal 20, the second fixed contact terminal 30 and the common fixed contact terminal 40 arranged on one line form switch parts SW1, SW2.

The first fixed contact terminal 20 is provided with a first fixed contact 21 arranged at an upper surface side of the base 10, and a first fixed terminal 22 arranged at a bottom surface side of the base 10. The second fixed contact terminal 30 is provided with a second fixed contact 31 arranged at the upper surface side of the base 10, and a second fixed terminal 32 arranged at the bottom surface side of the base 10. Further, the common fixed contact terminal 40 is provided with a common fixed contact 41 arranged at the upper surface side of the base 10, and a common fixed terminal 42 arranged at the bottom surface side of the base 10. Here, the first and the second fixed contacts 21, 31 are one example of the open and close fixed contact.

The first fixed contacts 21 are arranged on the upper surface of the base 10 at both ends of the short side at a side opposite to the support part 11 so as to be projected upwardly from the upper surface of the base 10. The first fixed contact 21 is provided with a vertical part extended upwardly from the upper surface of the base 10, and a horizontal part extended toward the support part 11 from an upper end part of the vertical part. The vertical part of the first fixed contact 21 is covered with an insulation member 23 and the horizontal part is exposed. The second fixed contact 31 is arranged below the horizontal part of the first fixed contact 21 so as to be projected upwardly from the upper surface of the base 10. The horizontal part of the first fixed contact 21 and the second fixed contact 31 are integrated via an insulation part 33 to form a single plate body. The plate body is formed to be flat such that a step is not formed between surfaces of the first fixed contact 21, the insulation part 33 and the second fixed contact 31. Further, the common fixed contact 41 is arranged to be located between the first and the second fixed contacts 21, 31 and the support part 11 and projected upwardly from the upper surface of the base 10.

As shown in FIG. 4, the first fixed terminal 22, the second fixed terminal 32 and the common fixed terminal 42 are arranged with predetermined intervals therebetween, and each of them is projected downwardly from the bottom surface of the base 10.

As shown in FIG. 3 and FIG. 4, the slide body 50 is provided with a main part 51, and two arms 52 extended in a parallel manner with a gap from both ends of one side surface of the main part 51.

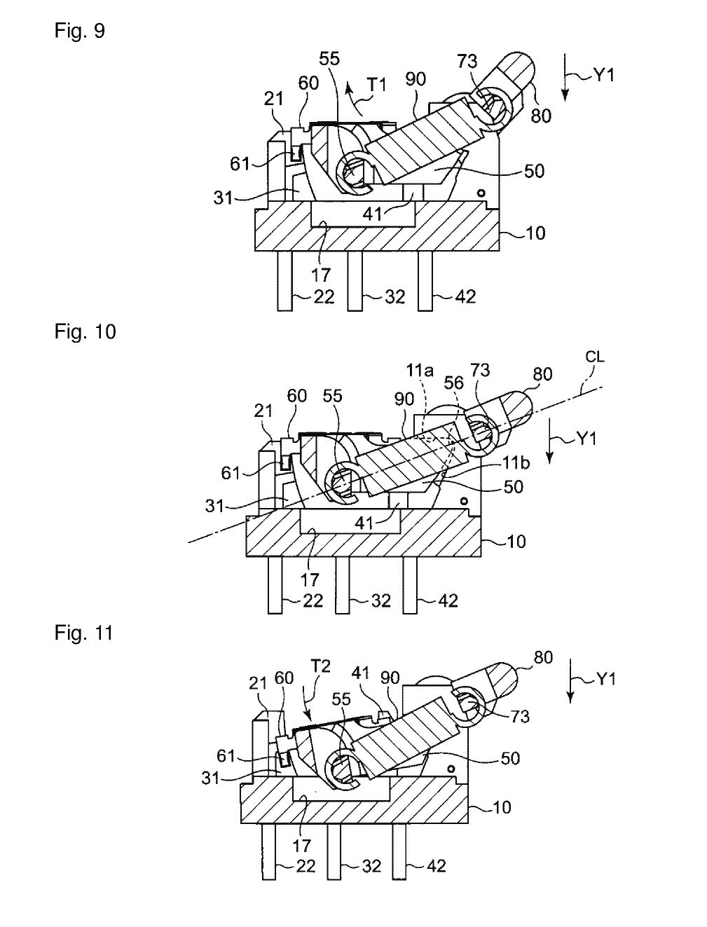

As shown in FIG. 3, the main part 51 is formed in a rectangular shape seen from an upper side. Slide body penetration holes 53 are arranged at both ends in a longitudinal direction of the upper surface of the main part 51. Each of the slide body penetration holes 53 is formed in a rectangular shape having a long side extended in a short direction of the main part 51 and a short side extended in a longitudinal direction of the main part 51. Projections 54 extended from the upper surface of the main part 51 toward a bottom surface of the main part 51 are arranged on both side surfaces in the longitudinal direction of the main part 51. Further, as shown in FIG. 4 and FIG. 9, a mount shaft 55 for mounting one end of the reverse spring 90 is arranged on the side surface of the main part 51 on which the arm 52 is arranged.

Each of the arms 52 is provided with a slide body rotation shaft 56 at a distal end of each arm 52. The slide body rotation shaft 56 is formed to be housed in the rotation receiving part 13 of the base 10 and arranged such that a contact part of the slide body rotation shaft 56 with the rotation receiving part 13 forms a pivot of the slide body 50. Further, a slide body projection 57 is arranged on an inward surface which faces another arm 52 of the slide body rotation shaft 56. The slide body projection 57 is formed to be fitted with the slide body mount hole 14 of the support part 11 of the base 10. Further, the slide body mount hole 14 of the base 10 and the slide body projection 57 of the slide body 50 form a temporary fixing mechanism for fixing the slide body 50 to the base 10 temporarily.

As shown in FIG. 3 and FIG. 4, the movable touch piece 60 is formed in a rectangular shape seen from an upper side which is formed by pressing and bending a single conductive spring plate. The movable touch piece 60 is provided with a pair of first movable contacts 61 and a pair of second movable contacts 62 arranged at both ends respectively, and a mount mechanism arranged between the first and the second movable contacts 61, 62. The movable touch piece 60 is formed to be movable with play in a short direction when the movable touch piece 60 is mounted to the slide body 50. Further, the first movable contact 61 is one example of the open and close movable contact, and the second movable contact 62 is one example of the common movable contact.

The first movable contact 61 is formed to elastically clamp the first and the second fixed contacts 21, 31 along the longitudinal direction of the movable touch piece 60. Further, the second movable contact 62 is formed to elastically clamp the common fixed contact along the longitudinal direction of the movable touch piece 60. The first and the second movable contacts 61, 62 are arranged to elastically clamp either of the first and the second fixed contacts 21, 31, and the common fixed contact 41 at the same time.

The mount mechanism of the movable touch piece 60 is provided with an insertion part 63 to be inserted into the slide body penetration hole 53 of the slide body 50, and an elastic arm 65 for fixing the movable touch piece 60 to the slide body 50. The insertion part 63 is formed in a rectangular plate body and extended in a perpendicular direction of the upper surface of the movable touch piece 60 from one side surface in the short direction of the movable touch piece 60. A latching pawl 64 is arranged at a center of a lower end of the insertion part 63. Further, the elastic arm 65 is formed in a folk like shape which can clamp the projection 54 of the slide body 50, and the elastic arm 65 is extended from another side surface in the short direction of the movable touch piece 60 so as to face the insertion part 63. A latching pawl 66 is arranged at a distal end of the elastic arm 65. Each of the latching pawls 64, 66 is formed to be engaged with the bottom surface of the slide body 50 when the movable touch piece 60 is mounted to the slide body 50.

Further, a projection 67 for enhancing rigidity is arranged between the first and the second movable contacts 61, 62 and the mount mechanism on the upper surface of the movable touch piece 60.

As shown in FIG. 3 and FIG. 4, the operation lever 70 is provided with an operation member 71, and a pair of lever support parts 72 arranged at both ends of one surface of the operation member 71.

The operation member 71 is formed in a rectangular plate body, and one curved surface is arranged in the short direction. Further, as shown in FIG. 4, a mount shaft 73 for mounting one end of the reverse spring 90 is arranged between the lever support parts 72 on a surface facing the curved surface.

Each of the lever support parts 72 is provided with an operation lever rotation shaft 74. The operation lever rotation shaft 74 is formed in a cylindrical shape and arranged such that the center of the operation lever rotation shaft 74 forms a pivot of the operation lever 70. That is, one operation lever rotation shaft 74 and another operation lever rotation shaft 74 are mutually extended in opposite directions along the longitudinal direction of the operation member 71, and center axes of both of the operation lever rotation shafts 74 are arranged on the same straight line. Temporary fixing holes 75 are arranged at both ends in an axial direction of the operation lever rotation shaft 74. The temporary fixing hole 75 penetrates the operation lever rotation shaft 74 in the axial direction, and the temporary fixing hole 75 is formed to be fitted with the base projection 15 of the support part 11 of the base 10. Further, the base projection 15 of the base 10 and the temporary fixing hole 75 of the operation lever 70 form a temporary fixing mechanism for fixing the operation lever 70 to the base 10 temporarily.

Further, a part of the operation member 71 forms one example of the operation part, and a part of the operation member 71 and the lever support part 72 and the mount shaft 73 form one example of the rotation part. That is, in the operation lever 70, the rotation part and the operation part are formed integrally.

A stepped part 76 is arranged between the operation member 71 and the lever support part 72. Further, the operation lever penetration hole 77 for mounting one end of the return spring 91 is arranged on the lever support part 72 at a side of the operation member 71.

As shown in FIG. 3 and FIG. 4, the cover 80 is opened at a bottom surface and formed in a substantially parallelepiped shape to be mounted to the base 10. In the cover 80, a cover mount hole 81 for mounting the cover 80 to the base 10, a support hole 82 for supporting the operation lever 70 in a rotatable manner, and an operation opening 83 to enable operation of the operation lever 70 are arranged.

The cover mount hole 81 is arranged at an opening side edge part of both side surfaces in the short direction of the cover 80 and formed to be fitted with the mount projection 18 of the base 10. The support hole 82 is formed to be fitted with the operation lever rotation shaft 74 of the operation lever 70. The support hole 82 is arranged at one corner at an upper surface side of the both side surfaces in the short direction of the cover 80. The support hole 82 supports the operation lever rotation shaft 74 in a rotatable manner. Further, the operation opening 83 is opened at the side surface at a side where the support hole 82 is arranged among the side surfaces in the longitudinal direction of the cover 80 and opened at a part of the upper surface of the cover 80.

Each of the reverse spring 90 and the return spring 91 is formed of, for example, carbon steel or stainless steel. The reverse spring 90 is formed as a coil spring, and both ends of the reverse spring 90 are formed to be mounted to the mount shaft 55 of the slide body 50 and the mount shaft 73 of the operation lever 70 respectively. Further, a spring length of the reverse spring 90 is adjusted such that elastic force is applied to the slide body 50 and the operation lever 70 to be always attracted to each other when the reverse spring 90 is mounted to the slide body 50 and the operation lever 70. The return spring 91 is formed as a torsion spring, and both ends of the return spring 91 are bent in the same direction, and one end of the return spring 91 is formed to be mounted to the spring mount hole 16 of the base 10. Further, a ring part 92 having an inner diameter into which the operation lever rotation shaft 74 of the operation lever 70 can be inserted is arranged in the return spring 91.

An assembling method of the switch 100 having the configuration described above is described with reference to FIG. 1, FIG. 2 and FIG. 5 to FIG. 8.

First, as shown in FIG. 5 and FIG. 6, the slide body 50 to which two movable touch pieces 60 are mounted is temporarily fixed to the base 10 on which two switch parts SW1, SW2 are arranged. At this time, as shown in FIG. 6, the slide body 50 is temporarily fixed to the base 10 in a state in which the slide body projection 57 is fitted with the slide body mount hole 14 of the base 10 and the first movable contacts 61 of the movable touch piece 60 clamp the first fixed contact 21, and the second movable contacts 62 clamp the common fixed contact 41.

Further, the movable touch piece 60 is mounted in a movable manner with play in the short direction, namely the rotation axis direction of the slide body 50, and the pair of the first movable contacts 61 and the pair of the second movable contacts 62 are mounted in the rotation axis direction of the slide body 50. Thus, even if an error is generated between a position in which the switch parts SW1, SW2 are arranged and a position in which the switch parts SW1, SW2 are designed, the movable touch piece 60 is moved in accordance with the position of the switch parts SW1, SW2 when the slide body 50 is mounted to the base 10, and thereby a position of the movable touch piece 60 is automatically adjusted. As a result, since it is not necessary to control positional accuracy of the switch parts SW1, SW2 severely, a manufacturing cost can be reduced.

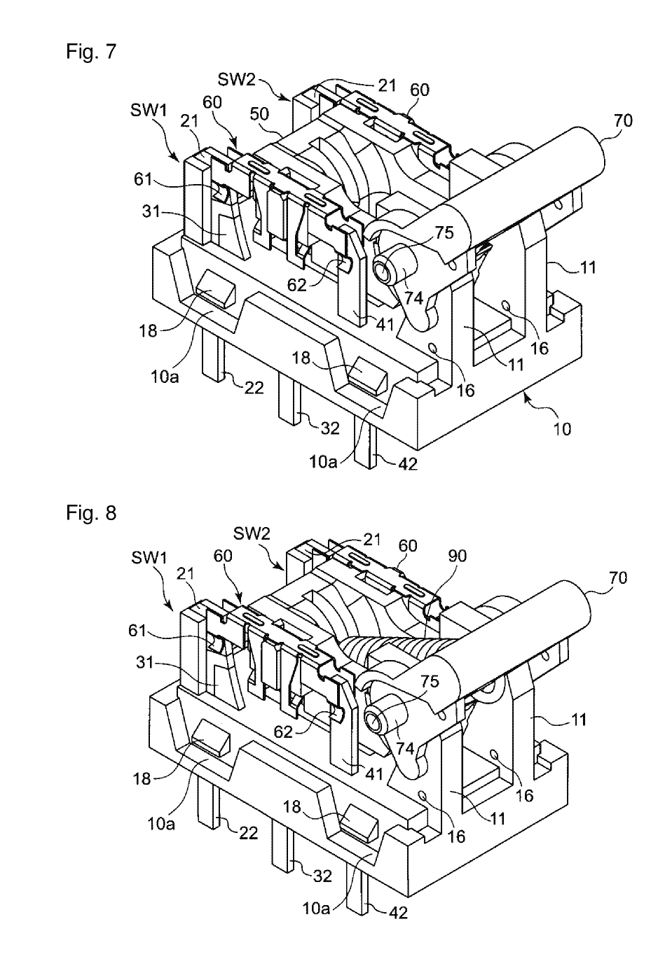

Next, as shown in FIG. 7, the base projection 15 (see FIG. 5 and FIG. 6) of the base 10 is fitted with the temporary fixing hole 75 of the operation lever 70, and thereby the operation lever 70 is temporarily fixed to the base 10.

When the slide body 50 and the operation lever 70 are temporarily fixed to the base 10, as shown in FIG. 8, the slide body 50 and the operation lever 70 are joined via the reverse spring 90 by mounting one end of the reverse spring 90 to the mount shaft 55 of the slide body 50 and by mounting another end of the reverse spring 90 to the mount shaft 73 of the operation lever 70. When the reverse spring 90 is mounted, the slide body 50 is attracted to the operation lever 70 by the reverse spring 90 and biased to be away from the base 10. Thus, the slide body 50 is supported on the base 10 in a rotatable manner in a state in which the slide body rotation shaft 56 is in contact with the rotation receiving part 13 of the base 10, and the slide body 50 is held at a first operation position defined by the lower surface 11a of the horizontal part of the support part 11 of the base 10.

Here, the first operation position corresponds to a position of the slide body 50 where the first movable contact 61 is in contact with the first fixed contact 21 and the second movable contact 62 is in contact with the common fixed contact 41 and thereby the first fixed contact 21 and the common fixed contact 41 are electrically connected to each other.

Next, as shown in FIG. 2, one end of the return spring 91 is mounted to the spring mount hole 16 of the base 10 such that the operation lever rotation shaft 74 is inserted into the ring part 92 of the return spring 91, and another end of the return spring 91 is mounted to the operation lever penetration hole 77 of the operation lever 70. After the return spring 91 is mounted, when the operation lever 70 is pressed down, the operation lever 70 is biased by the return spring 91 to be returned toward a return position shown in FIG. 2.

At last, as shown in FIG. 1, the mount projection 18 of the base 10 is fitted with the cover mount hole 81 of the cover 80, and thereby the cover 80 is mounted to the base 10, and the assembling process of the switch 100 is ended. At this time, the cover 80 is mounted to the base 10 such that the operation lever rotation shaft 74 of the operation lever 70 is fitted with the support hole 82 and the operation lever 70 is projected through the operation opening 83 of the cover 80 in an operable manner.

In this way, when the switch 100 is assembled, the slide body 50 and the operation lever 70 can be fixed temporarily to the base 10, and therefore temporary fixing can be performed before the product is completely assembled. Thus, this configuration facilitates the assembling of the switch 100, and therefore the productivity of the switch 100 can be enhanced.

Next, operation of the switch 100 having the configuration described above is described with reference to FIG. 9 to FIG. 14.

As described above, the switch 100 is provided with two switch parts SW1, SW2, and the switch parts SW1, SW2 are switched at substantially the same time.

As shown in FIG. 9, in a state in which the operation lever 70 is located at the return position, the slide body 50 is held at the first operation position and thereby the first fixed contact 21 and the common fixed contact 41 are electrically connected. At this time, torque T1 in a clockwise direction around the slide body rotation shaft 56 is applied to the slide body 50 by means of the elastic force of the reverse spring 90.

When the operation lever 70 is pressed in an Y1 direction and moved to a position shown in FIG. 10, the slide body rotation shaft 56 of the slide body 50 and an axial center CL of the reverse spring 90 are aligned on one straight line, and the torque T1 applied to the slide body 50 disappears. Further, at the moment when the operation lever 70 is further pressed in the Y1 direction and the operation lever 70 is pressed down to be located lower than the position shown in FIG. 10, torque T2 in a counterclockwise direction is applied to the slide body 50. That is, a direction of the torque applied to the slide body 50 is reversed from the clockwise direction to the counterclockwise direction, and thereby a snap action occurs.

When the torque T2 is applied to the slide body 50, the slide body 50 is biased toward the base 10 by means of elasticity of the reverse spring 90, and the slide body 50 is started to rotate in the counterclockwise direction around the slide body rotation shaft 56. Further, as shown in FIG. 11, the slide body 50 rotates toward a second operation position defined by the side surface 11b of the vertical part continued from the lower surface 11a of the horizontal part of the support part 11 and then stops.

Here, the second operation position corresponds to a position of the slide body 50 where the first movable contact 61 is in contact with the second fixed contact 31 and the second movable contact 62 is in contact with the common fixed contact 41 and thereby the second fixed contact 31 and the common fixed contact 41 are electrically connected to each other.

At this time, the first movable contact 61 of the movable touch piece 60 slides in the Y1 direction on a surface of a plate body formed by the first and the second fixed contacts 21, 31 while clamping the plate body, and the second movable contact 62 slides in the Y1 direction on the surface of the common fixed contact 41 while clamping the common fixed contact 41. That is, with the rotation of the slide body 50, the first movable contact 61 in contact with the first fixed contact 21 slides from the first fixed contact 21 to the second fixed contact 31 via the insulation part 33, and the second movable contact 62 slides on the surface of the common fixed contact 41.

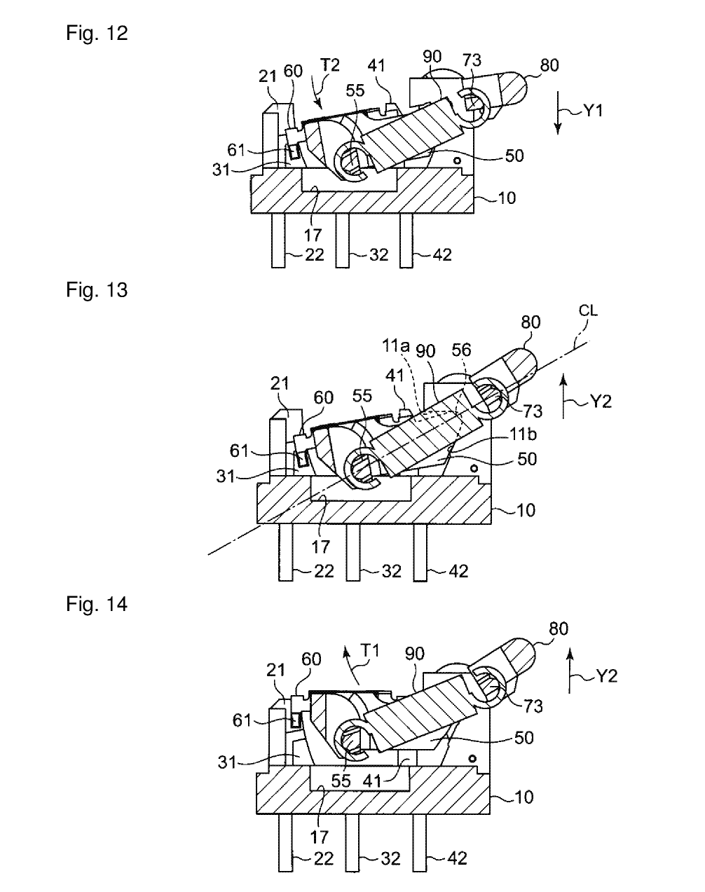

After that, the operation lever 70 is pressed down to a position shown in FIG. 12 so as to make contact with the support part 11 of the base 10 and then stopped.

When the pressing to the operation lever 70 is released, the operation lever 70 is pushed back in an Y2 direction shown in FIG. 13 by the elastic force of the return spring 91 to be returned to the return position shown in FIG. 14. When the operation lever 70 is moved from the position shown in FIG. 12 to the position shown in FIG. 13 by releasing the pressing to the operation lever 70, the slide body rotation shaft 56 of the slide body 50 and the axial center CL of the reverse spring 90 are aligned on one straight line, and the torque T2 applied to the slide body 50 disappears. Further, at the moment when the operation lever 70 is pushed back to be located upper than the position shown in FIG. 13, the torque T1 in the clockwise direction is applied to the slide body 50, and the direction of the torque applied to the slide body 50 is reversed from the counterclockwise direction to the clockwise direction, and thereby the snap action occurs.

In this way, the slide body 50 and the operation lever 70 rotatably supported on the base 10 are joined by the reverse spring 90, and when the operation lever 70 is rotated to the predetermined position, the slide body 50 rotates by means of the elastic force of the reverse spring 90 and thereby the first movable contact 61 and the first and the second fixed contacts 21, 31 are in contact with or separate from each other. That is, the conductive path is directly switched by outer force applied to the operation lever 70, and therefore a component such as an actuator is not necessary for transmitting the outer force to the operation lever 70. Thus, the number of the components and assembling processes of the switch 100 are reduced, and the productivity of the switch 100 can be enhanced.

Further, in the switch 100, when the operation lever 70 is rotated to the predetermined position, the slide body 50 rotates by means of the snap action due to the elastic force of the reverse spring 90, and thereby the first movable contact 61 slides such that the first movable contact 61 and the first and the second fixed contacts 21, 31 are in contact with or separate from each other, and the second movable contact 62 slides while in contact with the common fixed contact 41. Thus, since a foreign substance or the like generated on each surface of the first and the second movable contacts 61, 62 and the fixed contacts 21, 31, 41 is wiped, a wiping effect can be obtained, and therefore contact liability can be improved.

Further, when the switch parts SW1, SW2 are switched, the second movable contact 62 slides by the rotation of the slide body 50 while in contact with the common fixed contact 41. Thus, even if three or more switch parts are arranged, all switch parts can be switched at substantially the same time.

Further, in the switch 100, the slide body 50 and the operation lever 70 have respective pivots different from each other. That is, the operation lever rotation shaft 74 which forms the pivot of the operation lever 70 is arranged above the slide body rotation shaft 56 which forms the pivot of the slide body 50. Thus, the pressing force in the Y1 direction of the operation lever 70 necessary for rotating the slide body 50 can be reduced compared to a switch in which a pivot of the slide body 50 and a pivot the operation lever 70 are arranged at the same position. That is, large driving force to the slide body 50 can be obtained by small pressing force to the operation lever 70. As a result, even if three or more switch parts are arranged, the switch parts can be switched easily.

Further, in the switch 100, the rotation range of the slide body 50 is defined by the lower surface 11a of the horizontal part of the support part 11 and the side surface 11b of the vertical part continued from the lower surface 11a. Thus, the slide body 50 rotated by switching the switch parts SW1, SW2 stops when the slide body 50 collides with the horizontal part and the vertical part of the support part 11 located adjacent to the slide body rotation shaft 56 which forms the pivot of the slide body 50. In this way, since the horizontal part and the vertical part of the support part 11 are arranged adjacent to the slide body rotation shaft 56 which forms the pivot of the slide body 50, the slide body 50 collides with the horizontal part and the vertical part of the support part 11 at a low collision speed when the slide body 50 is rotated. Thus, a noise generated when the slide body 50 collides with the horizontal part and the vertical part of the support part 11 can be reduced.

### Other Embodiment

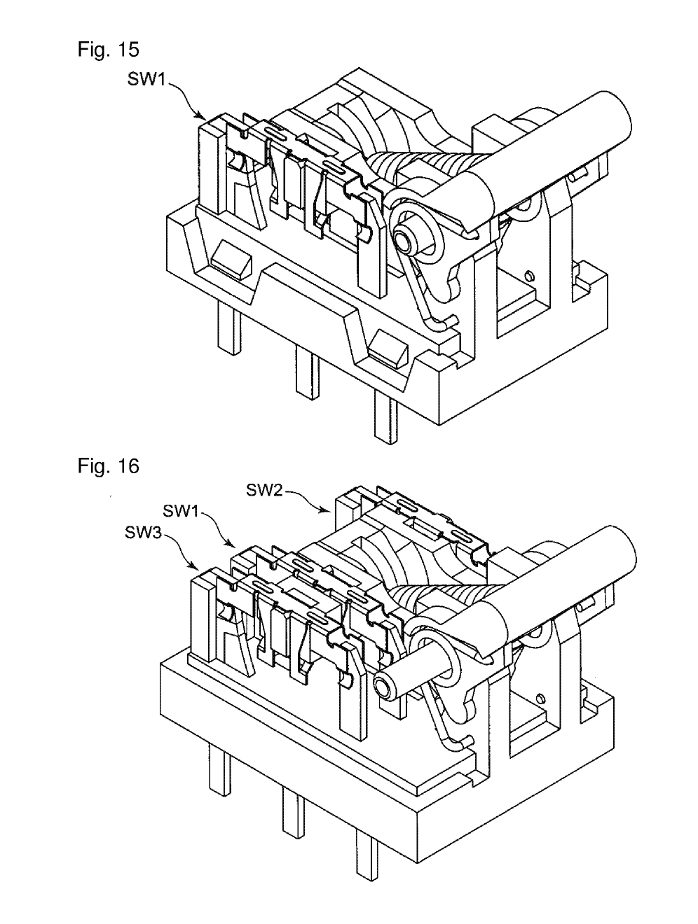

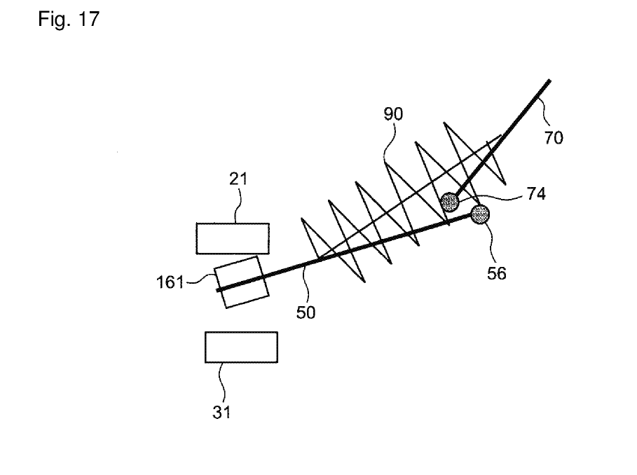

The number of the switch parts is not limited to two, and the number of the switch parts may be one (SW1) as shown in FIG. 15, or the number of the switch parts may be three (SW1 to SW3) as shown in FIG. 16, and although it is not illustrated, the number of the switch parts may be four or more. Further, the switch parts are not limited to be arranged in one line; however the switch parts may be arranged such that the fixed contacts are not arranged in one straight line.

In the switch 100 described above, the slide body 50 and the operation lever 70 are joined by the reverse spring 90 and the conductive path is directly switched by means of the outer force applied to the operation lever 70, however it is not limited to such a configuration. That is, the present invention can be applied to any switch as long as the switch has a configuration in which the open and close movable contact slides by means of the rotation of the slide body such that the open and close movable contact and at least one open and close fixed contact are in contact with or separate from each other and the common movable contact slides while in contact with the common fixed contact.

The assembling method of the switch is not limited to the embodiment described above. The base, the slide body and the operation lever may be assembled in any order as long as the reverse spring is mounted in a state in which the base, the slide body and the operation lever are assembled.

A metal material may be inserted into the rotation receiving part 13 of the base 10. With this, strength of the rotation receiving part 13 can be enhanced. Further, a bearing structure may be adopted instead of the rotation receiving part 13.

The plate body formed by the first and the second fixed contacts 21, 31 and the common fixed contact 41 may be formed in any size and in any shape as long as the first and the second movable contacts 61, 62 can slide by means of the rotation of the slide body 50 while in contact with the plate body formed by the first and the second fixed contacts 21, 31 and the common fixed contact 41, respectively.

In the slide body 50, the slide body penetration hole into which the movable touch piece is inserted, the slide body rotation shaft, and the mount shaft to which one end of the reverse spring is fixed may be formed integrally with each other, or alternatively may be formed separately from each other so as to be joined by an adhesive or the like to form the slide body. Further, the mount shaft 55 to which one end of the reverse spring 90 is fixed may be formed of metal material. With this, strength of the mount shaft 55 can be enhanced.

The movable touch piece 60 is fixed by inserting the insertion part 63 into the slide body penetration hole 53 of the slide body 50, however it is not limited to this. For example, the movable touch piece 60 may be formed integrally with the slide body 50 by means of insert molding, or alternatively may be fixed to the slide body 50 by means of thermal caulking. With this, fixing strength of the movable touch piece 60 to the slide body 50 can be enhanced.

In the operation lever 70, the operation member and the lever support part may be formed integrally, or alternatively may be formed separately from each other so as to be joined by an adhesive or the like to form the operation lever. Further, the mount shaft 73 to which one end of the reverse spring 90 may be formed of metal material. With this, strength of the mount shaft 73 can be enhanced.

Further, the operation body is not limited to the operation lever 70 as long as it can rotate the slide body 50, and therefore a shape, a size, and the number of components or the like may be set in any manner in accordance with design or the like of the switch. For example, the operation body is not limited to a configuration in which the operation body is supported in a rotatable manner, and the operation body may be supported in a linearly movable manner. Further, the operation lever 70 is not limited to a configuration in which the operation part and the rotation part are formed integrally, and the operation part and the rotation part may be formed separately and joined to each other, or alternatively the operation part may be provided with a plurality of components, for example, an actuator which transmits the outer force to the rotation part and the operation member for operating the actuator.

The reverse spring 90 may be formed of any material as long as it can show elastic force in accordance with the design of the switch 100. Further, the reverse spring 90 is not limited to the coil spring, and therefore a leaf spring, a torsion spring, a rubber or the like may be adopted.

The return spring 91 may be formed of any material as long as it can show elastic force to return the operation lever 70 to the return position against the elastic force of the reverse spring 90 when the operation lever 70 is pressed down. Further, the return spring 91 is not limited to the torsion spring, and therefore a coil spring, a leaf spring or the like may be adopted.

The temporary fixing mechanism for temporarily fixing the slide body 50 and the operation lever 70 to the base 10 is not limited to the configuration in the embodiment described above as long as the slide body 50 and the operation lever 70 can be temporarily fixed in a state in which the slide body 50 and the operation lever 70 are mounted to the base 10. For example, a projecting portion may be formed on the base and a recessed portion which can be fitted with the projecting portion may be formed on the slide body. Further, a recessed portion may be formed on the base and a projecting portion which can be fitted with the recessed portion may be formed on the operation lever.

The components described in the embodiment described above may be assembled as needed, and any of the components may be selected, replaced or deleted as needed.

### INDUSTRIAL APPLICABILITY

The switch according to the present invention can be used in, for example, an electric controlled parking brake for vehicles or the like.

### DESCRIPTION OF SYMBOLS

10 base
11 support part
12 notch
13 rotation receiving part
14 slide body mount hole
15 base projection
16 spring mount hole
17 recess
18 mount projection
20 first fixed contact terminal
21 first fixed contact
22 first fixed terminal
30 second fixed contact terminal
31 second fixed contact
32 second fixed terminal
40 common fixed contact terminal
41 common fixed contact
42 common fixed terminal
50 slide body
51 main part
52 arm
53 slide body penetration hole
54 projection
55 mount shaft
56 slide body rotation shaft
57 slide body projection
60 movable touch piece
61 first movable contact
62 second movable contact
63 insertion part
64 latching pawl
65 elastic arm
66 latching pawl
67 projection
70 operation lever
71 operation member
72 lever support part
73 mount shaft
74 operation lever rotation shaft
75 temporary fixing hole
76 stepped part
77 operation lever penetration hole
80 cover
81 cover mount hole
82 support hole
83 operation opening
90 reverse spring
91 return spring
100 switch
161 movable contact

1. A switch comprising:
a base;
at least one switch part arranged on the base and comprising a common fixed contact and at least one open and close fixed contact arranged with a predetermined interval between the common fixed contact and the at least one open and close fixed contact;
a slide body comprising a common movable contact configured to be in slidably contact with the common fixed contact and an open and close movable contact electrically connected to the common movable contact and configured to be in slidably contact with or separate from the open and close fixed contact, the slide body being configured to be rotatably supported by the base;
a cover mounted to the base to cover the switch part and the slide body;
an operation body configured to be movably supported by the base or the cover; and
an elastic body configured to bias the slide body and the operation body to be dose to each other,
wherein
the slide body is configured to be supported to rotate by a snap action due to elastic force of the elastic body when the operation member is moved to a predetermined position,
the open and dose movable contact is configured to slide in association with rotation of the slide body so as to be in contact with or separate from the open and dose fixed contact, and
the common movable contact is configured to slide in association with the rotation of the slide body while in contact with the common fixed contact.

2. The switch according to claim 1, wherein the operation body comprises a rotation part rotatably supported by the base or the cover, and an operation part joined to the rotation part, and
the slide body and the rotation part are arranged to have respective pivots different from each other.

3. The switch according to claim 1, wherein the slide body comprises a movable touch piece on which a pair of the open and close movable contacts and a pair of the common movable contacts are arranged, and
each of the pair of the open and close movable contacts and the pair of the common movable contacts is mounted in a rotation axial direction of the slide body and mounted in a movable manner such that the pair of the open and close movable contacts and the pair of the common movable contacts elastically clamp the open and close fixed contact and the common fixed contact respectively.

4. The switch according to claim 2, wherein the slide body comprises a movable touch piece on which a pair of the open and close movable contacts and a pair of the common movable contacts are arranged, and
each of the pair of the open and close movable contacts and the pair of the common movable contacts is mounted in a rotation axial direction of the slide body and mounted in a movable manner such that the pair of the open and close movable contacts and the pair of the common movable contacts elastically clamp the open and close fixed contact and the common fixed contact respectively.
